(19) United States
(12) Patent Application Publication
(10) Pub. No.: US 2008/0192751 A1
(43) Pub. Date: Aug. 14, 2008

(54) METHOD AND SYSTEM FOR SERVICE PROVISION

(75) Inventors: Wei Xiong, Shenzhen (CN); Yuanxiang Chen, Shenzhen (CN); Chenglong Liu, Shenzhen (CN); Xiaming Lai, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/106,178

(22) Filed: Apr. 18, 2008

Related U.S. Application Data
(63) Continuation of application No. PCT/CN2006/002715, filed on Oct. 16, 2006.

(30) Foreign Application Priority Data
Oct. 20, 2005 (CN) 200510100650.4

(51) Int. Cl. H04L 12/56

(52) U.S. Cl. 370/395.3

(57) ABSTRACT

A service provisioning method includes: a corresponding relation between the physical address of a terminal and the service information of a user is stored in a service server; after a service request from the terminal is receipted by the service server, the service requested for the user is determined by the service server according to the physical address of the terminal and the corresponding relation between the physical address of the terminal and the service information of the user; and the service is provided to the terminal by the service server. A service provisioning system comprises the terminal and the service server. The method and the system can realize the service provision automatically.

### CROSS-REFERENCE TO RELATED APPLICATIONS

This application is the continuation of International Patent Application No. PCT/CN2006/002715, filed on Oct. 16, 2006, which claims priority to Chinese Patent Application No. 200510100650.4, filed on Oct. 20, 2005, both the contents of which are hereby incorporated by reference in their entirety.

### FIELD OF THE INVENTION

The invention relates to the Next Generation Network NGN technology, and in particular, to a method and system for service provision.

### BACKGROUND OF THE INVENTION

Next Generation Network may provide a variety of services including telecommunication services such as Voice Over Internet Protocol VOIP, and IP television IPTV. These services are borne over IP networks. Generally, a terminal may obtain the IP address of the terminal via Dynamic Host Configuration DHCP or Point to Point Protocol Over Ethernet PPPOE, and send a service request to a service server (e.g. an Application Service Provider, ASP). The service server may provide a corresponding service to the terminal when receiving the service request sent from the terminal.

Generally, when a user wishes to apply for a service, such as VOIP or IPTV, the user is required to register the service to the network side, and obtain a service identifier and a password. In addition, the network side is required to configure the service server correspondingly, and notify relevant personnel to go to the user's resident to configure relevant service parameters in the terminal of the user. After the above configuration, the user may receive the service by use of the service identifier and password.

However, as user side devices, the terminals are numerous in number, are distributed through very wide geographical areas, and are of a variety of access types. Accordingly, the service that the relevant personnel visit each user may incur a very large cost of the operators. Therefore, to put services into operation rapidly, automatic service provision has attracted much attention of the operators. In addition, because of the lack of an authentication process in the method of obtaining an IP address via DHCP, an illegal user may exploit the advantage of a terminal to steal an IP address. This may give an illegal user a chance to attack the network by maliciously exhausting the IP address resources. Therefore, the security of automatic IP address acquisition via DHCP has become an important issue in service provision.

### SUMMARY OF THE INVENTION

In view of the above, an object of the invention is to provide a method and system for service provision, so as to provide services automatically.

To achieve the above object, the method for service provision according to the invention is as follows:

A service server stores a mapping relationship between a physical address of a terminal and service information of a terminal user. The method includes:

A. sending, by the terminal, a service request to the service server;

B. when receiving the service request from the terminal, determining, by the service server, a service applied by the terminal user according to the physical address of the terminal and the mapping relationship between the physical address of the terminal and the service information of the terminal user.

Before the step A, the method may further include: obtaining, by the terminal, an Internet Protocol address of the terminal and an Internet Protocol address of the service server;

The step A may include: sending, by the terminal, a service request, carrying the Internet Protocol address of the terminal, to the service server according to the Internet Protocol address of the service server;

Before determining by the service server a service applied by the terminal user, the step B may further include: determining, by the service server, the physical address of the terminal initiating the service request according to the Internet Protocol address of the terminal.

Obtaining by the terminal an Internet Protocol address of the terminal may include:

initiating, by the terminal, a dynamic host configuration protocol request after powered on, to request to allocate an Internet Protocol address;

when receiving the dynamic host configuration protocol request, inserting, by a broadband remote access server, the physical address of the terminal into the dynamic host configuration protocol request, and sending the dynamic host configuration protocol request with the physical address of the terminal to a dynamic host configuration protocol server;

when receiving the dynamic host configuration protocol request, parsing, by the dynamic host configuration protocol server, the physical address of the terminal from the dynamic host configuration protocol request, allocating an Internet Protocol address for the terminal, generating a mapping relationship between the physical address and the Internet Protocol address of the terminal, and sending the allocated Internet Protocol address to the terminal.

Before the step A, the method may further include: obtaining, by the terminal, a terminal configuration file to complete an initial configuration.

The method may further include: configuring the mapping relationship between the physical address and the Internet Protocol address of the terminal on the dynamic host configuration protocol server;

Allocating the Internet Protocol address for the terminal may include: allocating, by the dynamic host configuration protocol server, the Internet Protocol address for the terminal according to the configured mapping relationship between the physical address and the Internet Protocol address of the terminal.

Or, allocating the Internet Protocol address for the terminal may include: randomly selecting, by the dynamic host configuration protocol server, an available Internet Protocol address for the terminal.

The method may further include: storing the mapping relationship between the physical address of the terminal and the service information of the terminal user on the dynamic host configuration protocol server;

Before allocating the Internet Protocol address for the terminal, the method may further include: parsing, by the dynamic host configuration protocol server, the physical address of the terminal from the dynamic host configuration protocol request, and judging whether the physical address of the terminal is contained in the mapping relationship between the physical address of the terminal and the service information of the terminal user stored on the dynamic host configuration protocol server; if the physical address of the terminal is contained in the mapping relationship, the dynamic host configuration protocol server allocates the Internet Protocol address for the terminal, if the physical address of the terminal is not contained in the mapping relationship, the dynamic host configuration protocol server does not allocate the Internet Protocol address for the terminal.

Obtaining by the terminal the Internet Protocol address of the service server may include: when receiving the dynamic host configuration protocol request, determining, by the dynamic host configuration protocol server, the Internet Protocol address of the service server, and sending the Internet Protocol address of the service server to the terminal.

The method may further include: configuring a mapping relationship between the physical address of the terminal and the Internet Protocol address of the service server on the dynamic host configuration protocol server;

Determining the Internet Protocol address of the service server may include: parsing, by the dynamic host configuration protocol server, the physical address of the terminal from the dynamic host configuration protocol request, determining the Internet Protocol address of the service server according to the parsed physical address of the terminal and the mapping relationship between the physical address of the terminal and the Internet Protocol address of the service server.

The method may further include: configuring a unified Internet Protocol address of service servers on the dynamic host configuration protocol server;

Determining the Internet Protocol address of the service server may include: selecting, by the dynamic host configuration protocol server, the unified Internet Protocol address of service servers.

The method may further include: sending, by the dynamic host configuration protocol server, the generated mapping relationship between the physical address and the Internet Protocol address of the terminal to the service server;

Determining by the service server the physical address of the terminal may include: determining, by the service server, the physical address of the terminal initiating the service request, according to the Internet Protocol address of the terminal carried in the service request and the mapping relationship between the physical address and the Internet Protocol address of the terminal sent from the dynamic host configuration protocol server.

Or, determining by the service server the physical address of the terminal may include: requesting, by the service server, the dynamic host configuration protocol server to provide the physical address of the terminal corresponding to the Internet Protocol address of the terminal carried in the service request.

Obtaining by the terminal the terminal configuration file may include:

when receiving the dynamic host configuration protocol request, determining, by the dynamic host configuration protocol server, an Internet Protocol address of a network management server, and sending the Internet Protocol address of the network management server to the terminal;

when receiving the Internet Protocol address of the network management server, sending, by the terminal, a request to the network management server, requesting the network management server to provide the terminal configuration file;

when receiving the request sent from the terminal, returning, by the network management server, the terminal configuration file to the terminal.

The method may further include: configuring a mapping relationship between the physical address of the terminal and the Internet Protocol address of the network management server on the dynamic host configuration protocol server;

Determining the Internet Protocol address of the network management server may include: parsing, by the dynamic host configuration protocol server, the physical address of the terminal from the dynamic host configuration protocol request, determining the Internet Protocol address of the network management server according to the parsed physical address of the terminal and the mapping relationship between the physical address of the terminal and the Internet Protocol address of the network management server.

The method may further include: configuring a unified Internet Protocol address of network management servers on the dynamic host configuration protocol server;

Determining the Internet Protocol address of the network management server may include: selecting, by the dynamic host configuration protocol server, the unified Internet Protocol address of network management servers.

The method may further include: storing a mapping relationship between the physical address of the terminal and the terminal configuration file on the network management server;

Returning the terminal configuration file to the terminal may include: determining, by the network management server, the terminal configuration file corresponding to the terminal according to the physical address of the terminal and the mapping relationship between the physical address of the terminal and the terminal configuration file stored on the network management server, and sending the terminal configuration file to the terminal.

The request requesting the network management server to provide the terminal configuration file may carry the Internet Protocol address of the terminal;

Before returning the terminal configuration file to the terminal, the method may further include: determining, by the network management server, the physical address of the terminal initiating the request according to the Internet Protocol address of the terminal carried in the request.

The method may further include: sending, by the dynamic host configuration protocol server, the generated mapping relationship between the physical address and the Internet Protocol address of the terminal to the network management server;

Determining by the network management server the physical address of the terminal may include: determining, by the network management server, the physical address of the terminal initiating the request according to the Internet Protocol address of the terminal carried in the request and the mapping relationship between the physical address and the Internet Protocol address of the terminal sent from the dynamic host configuration protocol server.

Or, determining by the network management server the physical address of the terminal may include: requesting, by the network management server, the dynamic host configuration protocol server to provide the physical address of the terminal corresponding to the Internet Protocol address of the terminal carried in the request.

When returning the terminal configuration file to the terminal, the method may further include: sending, by the network management server, an Internet Protocol address of the service server to the terminal.

The terminal may be a set top box STB, or an integrated access device IAD, or a home gateway HGW, or a network telephone Ephone, or a personal computer PC, or any other next generation network terminal.

A system for service provision according to the invention may include: a terminal and a service server,

The terminal is adapted to send a service request to the service server, and receive a service provided by the service server;

the service server is adapted to store a mapping relationship between a physical address of the terminal and service information of a terminal user, receive the service request sent from the terminal, determine a service applied by the terminal user according to the physical address of the terminal and the mapping relationship between the physical address of the terminal and the service information of the terminal user, and provide the service to the terminal.

The service request may include an Internet Protocol address of the terminal;

The service server is further adapted to determine the physical address of the terminal initiating the service request according to the Internet Protocol address of the terminal carried in the service request.

The system may further include: a dynamic host configuration protocol server and a broadband remote access server,

the terminal is further adapted to initiate a dynamic host configuration protocol request, requesting to allocate an Internet Protocol address, and receive the Internet Protocol address of the terminal sent from the dynamic host configuration protocol server;

the broadband remote access server is adapted to receive the dynamic host configuration protocol request initiated by the terminal, insert the physical address of the terminal into the dynamic host configuration protocol request, and send the dynamic host configuration protocol request with the physical address of the terminal to the dynamic host configuration protocol server;

the dynamic host configuration protocol server is adapted to receive the dynamic host configuration protocol request, parse the physical address of the terminal from the dynamic host configuration protocol request, allocate an Internet Protocol address for the terminal, generate a mapping relationship between the physical address and the Internet Protocol address of the terminal, and send the allocated Internet Protocol address to the terminal.

The system may further include: a network management server,

the terminal is further adapted to send a request to the network management server requesting the network management server to provide a terminal configuration file, receive the terminal configuration file sent from the network management server, to complete an initial configuration;

the network management server is adapted to receive the request sent from the terminal, and return the terminal configuration file to the terminal.

The dynamic host configuration protocol server may be further adapted to authenticate validity of the terminal.

The dynamic host configuration protocol server may be further adapted to determine an Internet Protocol address of the service server when receiving the dynamic host configuration protocol request, and send the determined Internet Protocol address of the service server to the terminal;

the terminal may be further adapted to receive the Internet Protocol address of the service server sent from the dynamic host configuration protocol server.

The dynamic host configuration protocol server may be further adapted to determine an Internet Protocol address of the network management server, and send the determined Internet Protocol address of the network management server to the terminal;

the terminal may be further adapted to receive the Internet Protocol address of the network management server sent from the dynamic host configuration protocol server.

The network management server may be further adapted to store a mapping relationship between the physical address of the terminal and the terminal configuration file, determine the terminal configuration file corresponding to the terminal according to the physical address of the terminal and the mapping relationship between the physical address of the terminal and the terminal configuration file stored on the network management server.

The request requesting the network management server to provide the terminal configuration file may carry the Internet Protocol address of the terminal;

the network management server may be further adapted to determine the physical address of the terminal initiating the request according to the Internet Protocol address of the terminal carried in the request.

The network management server may be further adapted to send an Internet Protocol address of the service server to the terminal;

the terminal may be further adapted to receive the Internet Protocol address of the service server sent from the network management server.

The terminal may be a set top box STB, or an integrated access device IAD, or a home gateway HGW, or a network telephone Ephone, or a personal computer PC, or any other next generation network terminal.

As can be seen from the above solutions, in the invention, after a terminal is powered on, a service server may provides services automatically according to a mapping relationship between the preconfigured physical address of the terminal and service information of a terminal user, without any human intervention during the whole process of service provision. In this way, the maintenance cost of the operators may be saved greatly. In addition, when the terminal tries to obtain an IP address via DHCHP, the DHCP server may authenticate the validity of the terminal, and allocate the IP address only if the authentication is passed. In this way, the problem that an illegal user may attack o the network by maliciously exhausting the IP address resources may be avoided. Therefore, the security in obtaining an IP address via DHCP may be improved, and the IP address resources may be saved.

### BRIEF DESCRIPTION OF THE DRAWINGS

FIG. 1 is a schematic diagram illustrating a structure of a system for service provision according to the invention;

FIG. 2 is a schematic diagram illustrating a structure of a system for service provision according to a first embodiment of the invention;

FIG. 3 is a flow chart illustrating a method for service provision according to the first embodiment of the invention;

FIG. 4 is a schematic diagram illustrating a structure of a system for service provision according to a second embodiment of the invention; and

FIG. 5 is a flow chart illustrating a method for service provision according to the second embodiment of the invention.

### DETAILED DESCRIPTION OF THE EMBODIMENTS

To make the object, the technical solutions and advantages of the invention better understood, some embodiments of the invention are described below in conjunction with the accompanying drawings.

The basic concept of a method for service provision according to the invention lies in that, a mapping relationship between a physical address of a terminal and service information of a terminal user is generated on a service server. When receiving a service request from the terminal, the service server may determine a service applied by the terminal user according to the mapping relationship between the physical address of the terminal and the service information of the terminal user, and provide the service to the terminal.

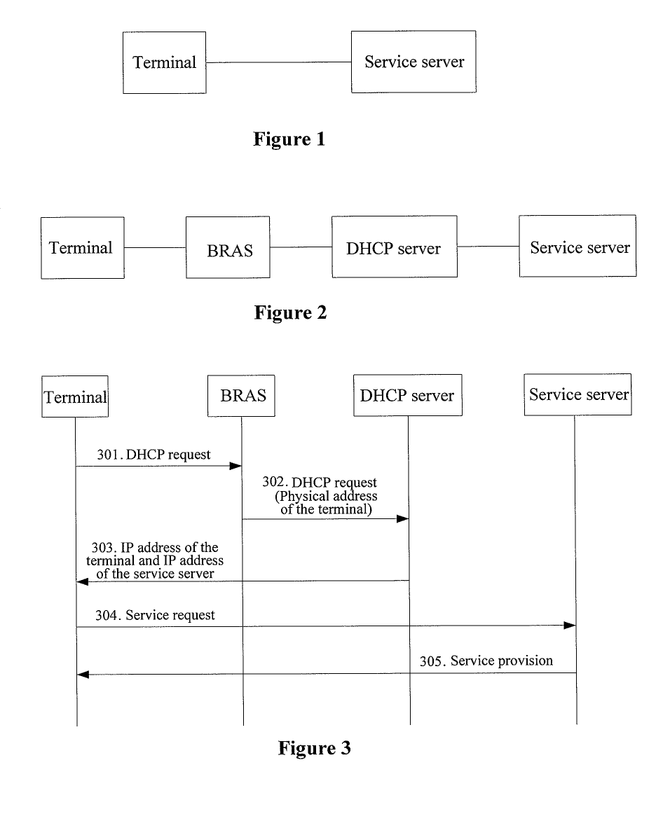

FIG. 1 illustrates a system for service provision, corresponding to the above method for service provision. As shown in FIG. 1, the system includes a terminal and a service server. The terminal is adapted to send a service request to the service server, and receive a service provided by the service server. The service server is adapted to store a mapping relationship between a physical address of the terminal and service information of a terminal user, receive the service request sent from the terminal, determine a service applied by the terminal user according to the mapping relationship between the physical address of the terminal and the service information of the terminal user, and provide the service to the terminal.

The terminal may be a Set Top Box STP, an Integrated Access Device IAD, a Home Gateway HGW, a network telephone Ephone, a personal computer PC or any other NGN terminal.

The physical address of the terminal may be determined according to network planning and the resident address of the terminal user. The format of the physical address may be “node identifier+frame number/slot number/sub-slot number/port number+[vpi,vci]+[vlan]”. If concepts of frames and sub-slots are not available for some devices, the corresponding positions in the physical address may be filled with “0”. For example, supposing the physical address of a terminal is “bantianMA5100atm 0/1/0/1:0.35”, then the node identifier is “bantianMA5100”, the frame number is “0”, the slot number is “1”, the sub-slot number is “0”, the port number is “1”, VPI is “0”, and VCI is “35”.

The terminal according to the invention may be classified into two types, i.e. terminal with initial configuration and terminal without initial configuration. Some embodiments of the invention are described below, in which the above two types of terminal are utilized respectively.

### Embodiment 1

FIG. 2 illustrates a system for service provision including a terminal with an initial configuration. As shown in FIG. 2, the system for service provision may further include a Broadband Remote Access Server BRAS and a Dynamical Host Configuration Protocol DHCP server. The terminal is further adapted to initiate a DHCP request, requesting to allocate an IP address, and receive the IP address of the terminal and an IP address of the service server from the DHCP server. BRAS is adapted to receive the DHCP request from the terminal, insert the physical address of the terminal into the DHCP request, and send the DHCP request with the physical address of the terminal to the DHCP server. The DHCP server is adapted to receive the DHCP request, allocate the IP address for the terminal, determine the IP address of the service server, and send the allocated IP address of the terminal and the determined IP address of the service server to the terminal.

FIG. 3 illustrates a method for service provision according to the embodiment. The method is described below in conjunction with the system as shown in FIG. 2. As shown in FIG. 3, the method is as follows.

In step 301, after powered on, the terminal automatically initiates a DHCP request, requesting to allocate an IP address.

In step 302, when receiving the DHCP request, the BRAS inserts the physical address of the terminal into the DHCP request (for example, the physical address of the terminal may be inserted into “OPTIONS” of the DHCP request), and send the DHCP request with the physical address of the terminal to the DHCP server.

In step 303, when receiving the DHCP request, the DHCP server parses the physical address of the terminal from the DHCP request, allocates an IP address for the terminal, determines an IP address of the service server, and sends the IP address of the terminal and the IP address of the service server to the terminal. In addition, the DHCP server generates a mapping relationship between the physical address and the IP address of the terminal, and sends the mapping relationship between the physical address and the IP address of the terminal to the service server.

If a mapping relationship between the physical address of the terminal and the IP address of the service server is configured on the DHCP server, the DHCP server may find the IP address of the service server according to the parsed physical address of the terminal and the mapping relationship between the physical address of the terminal and the IP address of the service server. If a unified IP address of service servers is configured on the DHCP server, the DHCP server may select the unified IP address for the service server. The DHCP server delivers the IP address of the service server and the IP address of the terminal to the terminal via a DHCP answer message. In an embodiment, the DHCP answer message is sent to the terminal via the BRAS. Before forwarding the DHCP answer message, the BRAS may remove the physical address of the terminal from the DHCP answer message.

In addition, to ensure the security of automatic acquisition of the IP address of the terminal by DHCP, the DHCP server may authenticate the validity of the terminal first, so as to prevent an illegal user from attacking the network by maliciously exhausting the IP address resources of the network. For example, the DHCP server may store the mapping relationship between the physical addresses of terminals and service information of terminal users, generate a list of the mapping relationship between the physical addresses of terminals and service information of terminal users. When parsing the physical address of a terminal from a DHCP request, the DHCP server queries whether the physical address of the terminal is stored in the list. If the physical address of the terminal is stored in the list, it is indicated that the terminal is a legal terminal. If the physical address of the terminal is not stored in the list, it is indicated that the terminal is an illegal terminal, and the DHCP server does not allocate an IP address for the illegal terminal. If the DHCP server has preconfigured a mapping relationship between the IP address and the physical address of the terminal, the DHCP server may allocate the IP address for the terminal according to the preconfigured mapping relationship. If the DHCP server has not preconfigured a mapping relationship between the IP address and the physical address of the terminal, the DHCP server may randomly select an available IP address for the terminal.

In step 304, when obtaining the IP address of the terminal and the IP address of the service server, the terminal initiates a service request to the service server according to the IP address of the service server. The service request may include the IP address of the terminal.

In step 305, when receiving the service request, the service server determines the physical address of the terminal according to the IP address of the terminal carried in the service request and the mapping relationship between the physical address and the IP address of the terminal sent from the DHCP server, determines a service applied by the terminal user according to the determined physical address of the terminal and the mapping relationship between the physical address of the terminal and service information of the terminal user stored in the service server, and provides the service to the terminal.

In addition, in step 303, the DHCP server may send the mapping relationship between the physical address and the IP address of the terminal to the service server before sending the IP address of the terminal and the IP address of the service server to the terminal, to prevent the situation that the service server may reject to provide the service to the terminal because of an inconsistency between the physical address of the terminal reported to the service server by the DHCP server and the IP address of the terminal.

If the DHCP server does not send the mapping relationship between the physical address and the IP address of the terminal to the service server in step 303, in step 305, the service server may query the DHCP server for the physical address of the terminal corresponding to the IP address of the terminal carried in the service request when the service server receives the service request initiated from the terminal.

### Embodiment 2

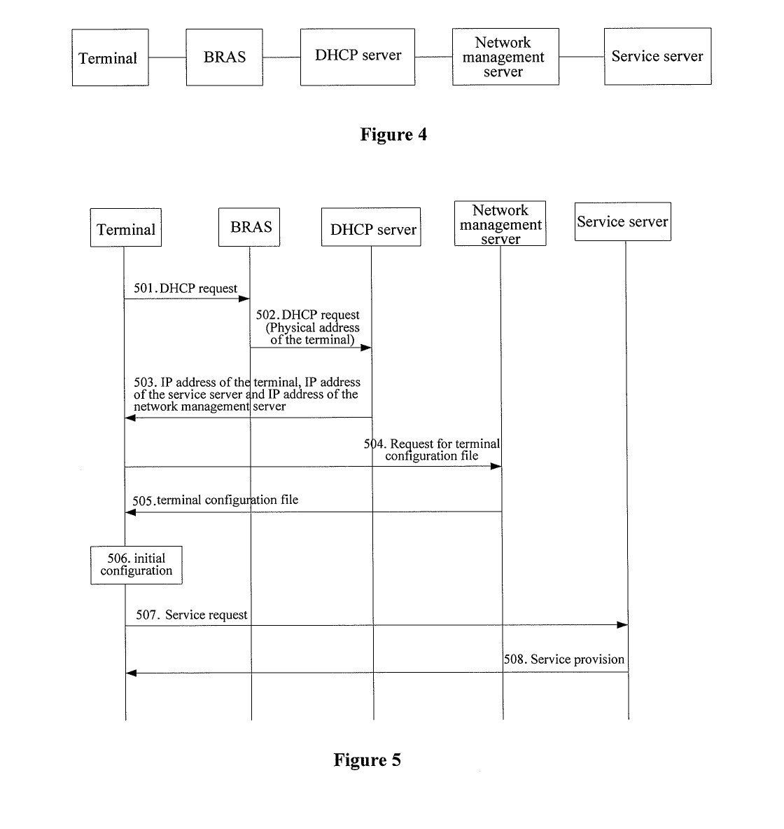

FIG. 4 illustrates a system for service provision including a terminal without an initial configuration. As shown in FIG. 4, the system for service provision according to the embodiment may further include a network management server in comparison with that as shown in FIG. 2. The terminal is further adapted to send a request to the network management server requesting the network management server to provide a terminal configuration file, and receive the terminal configuration file sent from the network management server, to perform an initial configuration. The network management server is adapted to receive the request from the terminal, and return the terminal configuration file to the terminal.

A mapping relationship between the physical address of the terminal and the terminal configuration file may be preconfigured on the network management server. The terminal configuration file may include terminal software and terminal configuration parameters. The terminal software is application programs operating in an embedded operation system on the terminal. The terminal configuration parameters include related configuration parameters (e.g. terminal identifier, and ports used by the terminal) of the terminal and some configuration parameters (e.g. user name and password for accessing the service server, numbers of accessed ports, and service identifiers) of services. The terminal configuration parameters may be different from one terminal to another.

FIG. 5 illustrates a method for service provision according to the embodiment. The method is described below in conjunction with the system as shown in FIG. 4. As shown in FIG. 5, the method is as follows.

Steps 501-502 are same as steps 301-302 respectively, and are not repeated herein.

Step 503 is similar to step 303. The difference lies in that, in addition to sending the IP address allocated to the terminal and the IP address of the service server to the terminal, the DHCP server further determines the IP address of the network management server, sends the IP address of the network management server to the terminal, and sends the mapping relationship between the physical address and the IP address of the terminal to the network management server.

If a mapping relationship between the physical address of the terminal and the IP address of the network management server is configured on the DHCP server, the DHCP server may find the IP address of the network management server according to the parsed physical address of the terminal and the mapping relationship between the physical address of the terminal and the IP address of the network management server. If a unified IP address of network management servers is configured on the DHCP server, the DHCP server may select the unified IP address for the network management server. The DHCP server delivers the IP address of the network management server, the IP address of the service server and relevant network configuration parameters (such as mask, domain name server, domain name, and route information) including the IP address of the terminal to the terminal via a DHCP answer message. For example, the DHCP server may return the mask via OPTION1 in the DHCP answer message, return the route information via OPTION3 in the DHCP answer message, return the domain name server via OPTION6 in the DHCP answer message, return the domain name via OPTION15 in the DHCP answer message, return the IP address of the network management server via OPTION43 in the DHCP answer message, and return the IP address of the service server via OPTION120 in the DHCP answer message.

In step 504, when the terminal obtains its own IP address and the IP address of the network management server, the terminal registers to the network management server, sends a request to the network management server requesting the network management server to provide a terminal configuration file. The request may carry the IP address of the terminal.

In step 505, when receiving the request from the terminal, the network management server determines the physical address of the terminal initiating the request according to the IP address of the terminal carried in the request and the mapping relationship between the physical address and the IP address of the terminal sent from the DHCP server, determines the terminal configuration file corresponding to the terminal according to the physical address of the terminal and a mapping relationship between the physical address of the terminal and the terminal configuration file, and sends the terminal configuration file to the terminal.

If the terminal configuration file corresponding to the terminal has not been configured on the network management server, the network management server may generate the terminal configuration file dynamically.

If the DHCP server does not send the mapping relationship between the physical address and the IP address of the terminal to the network management server in step 503, in step 505, the network management server may query the DHCP server for the physical address of the terminal corresponding to the IP address of the terminal carried in the request when the network management server receives the request initiated from the terminal.

In step 506, the terminal receives the terminal configuration file sent from the network management server, and completes an initial configuration.

Steps 507-508 are same as steps 304-305 respectively, and are not repeated herein.

The IP address of the service server may be delivered to the terminal by the network management server when the network management server delivers the terminal configuration file, instead of being delivered by the DHCP server.

In addition, when detecting that the terminal is offline, the DHCP server may send a request to the service server and the network management server requesting to remove the bonding relationship of the IP addresses, so as to release the IP address allocated to the terminal, thereby saving the IP address resources.

While the object, the technical solutions and the beneficial effects of the invention have been described above, it shall be appreciated that the invention should not be limited to these. Any modifications, equivalent substitutions and improvements made within the scope of the invention should be covered within the protection scope of the invention.

What is claimed is:

1. A method for service provision, wherein a mapping relationship between a physical address of a terminal and service information of a terminal user is stored in a service server, the method comprises:
sending, by the terminal, a service request to the service server;
when receiving the service request from the terminal, determining, by the service server, a service applied by the terminal user according to the physical address of the terminal and the mapping relationship between the physical address of the terminal and the service information of the terminal user stored in the service server, and providing the service to the terminal.

2. The method according to claim 1, wherein before the process of sending a service request to the service server, the method further comprises: obtaining, by the terminal, an Internet Protocol address of the terminal and an Internet Protocol address of the service server;
the process of sending a service request to the service server comprises: sending, by the terminal, a service request, carrying the Internet Protocol address of the terminal, to the service server according to the Internet Protocol address of the service server; and
before determining by the service server the service applied by the terminal user, further comprises: determining, by the service server, the physical address of the terminal initiating the service request according to the Internet Protocol address of the terminal carried in the service request.

3. The method according to claim 2, wherein obtaining by the terminal the Internet Protocol address of the terminal comprises:
initiating, by the terminal, a dynamic host configuration protocol request after powered on, to request to allocate an Internet Protocol address;
when receiving the dynamic host configuration protocol request, inserting, by a broadband remote access server, the physical address of the terminal into the dynamic host configuration protocol request, and sending the dynamic host configuration protocol request with the physical address of the terminal to a dynamic host configuration protocol server; and
when receiving the dynamic host configuration protocol request, parsing, by the dynamic host configuration protocol server, the physical address of the terminal from the dynamic host configuration protocol request, allocating an Internet Protocol address for the terminal, generating a mapping relationship between the physical address and the Internet Protocol address of the terminal, and sending the allocated Internet Protocol address to the terminal.

4. The method according to claim 3, wherein before the process of sending a service request to the service server, the method further comprises: obtaining, by the terminal, a terminal configuration file to complete an initial configuration.

5. The method according to claim 3, further comprising: configuring the mapping relationship between the physical address and the Internet Protocol address of the terminal on the dynamic host configuration protocol server; wherein
allocating the Internet Protocol address for the terminal comprises: allocating, by the dynamic host configuration protocol server, the Internet Protocol address for the terminal according to the configured mapping relationship between the physical address and the Internet Protocol address of the terminal.

6. The method according to claim 3, wherein allocating the Internet Protocol address for the terminal comprises: randomly selecting, by the dynamic host configuration protocol server, an available Internet Protocol address for the terminal.

7. The method according to claim 3, further comprising: storing the mapping relationship between the physical address of the terminal and the service information of the terminal user on the dynamic host configuration protocol server; and
before allocating the Internet Protocol address for the terminal, the method further comprises: parsing, by the dynamic host configuration protocol server, the physical address of the terminal from the dynamic host configuration protocol request, and judging whether the physical address of the terminal is contained in the mapping relationship between the physical address of the terminal and the service information of the terminal user stored on the dynamic host configuration protocol server; wherein if the physical address of the terminal is contained in the mapping relationship, the dynamic host configuration protocol server allocates the Internet Protocol address for the terminal, and if the physical address of the terminal is not contained in the mapping relationship, the dynamic host configuration protocol server does not allocate the Internet Protocol address for the terminal.

8. The method according to claim 3, wherein the obtaining by the terminal the Internet Protocol address of the service server comprises:
when receiving the dynamic host configuration protocol request, determining, by the dynamic host configuration protocol server, the Internet Protocol address of the service server, and sending the Internet Protocol address of the service server to the terminal.

9. The method according to claim 8, further comprising: configuring a mapping relationship between the physical address of the terminal and the Internet Protocol address of the service server on the dynamic host configuration protocol server; wherein
determining the Internet Protocol address of the service server comprises: parsing, by the dynamic host configuration protocol server, the physical address of the terminal from the dynamic host configuration protocol request, determining the Internet Protocol address of the service server according to the parsed physical address of the terminal and the configured mapping relationship between the physical address of the terminal and the Internet Protocol address of the service server.

10. The method according to claim 8, further comprising: configuring a unified Internet Protocol address of service servers on the dynamic host configuration protocol server; wherein
determining the Internet Protocol address of the service server comprises: selecting, by the dynamic host configuration protocol server, the unified Internet Protocol address of service servers.

11. The method according to claim 8, further comprising: sending, by the dynamic host configuration protocol server, the generated mapping relationship between the physical address and the Internet Protocol address of the terminal to the service server; wherein
determining by the service server the physical address of the terminal comprises: determining, by the service server, the physical address of the terminal initiating the service request, according to the Internet Protocol address of the terminal carried in the service request and the mapping relationship between the physical address and the Internet Protocol address of the terminal sent from the dynamic host configuration protocol server.

12. The method according to claim 3, wherein determining by the service server the physical address of the terminal comprises:
requesting, by the service server, the dynamic host configuration protocol server to provide the physical address of the terminal corresponding to the Internet Protocol address of the terminal carried in the service request.

13. The method according to claim 4, wherein obtaining by the terminal the terminal configuration file comprises:
when receiving the dynamic host configuration protocol request, determining, by the dynamic host configuration protocol server, an Internet Protocol address of a network management server, and sending the Internet Protocol address of the network management server to the terminal;
when receiving the Internet Protocol address of the network management server, sending, by the terminal, a request to the network management server, requesting the network management server to provide the terminal configuration file; and
when receiving the request sent from the terminal, returning, by the network management server, the terminal configuration file to the terminal.

14. The method according to claim 13, further comprising: configuring a mapping relationship between the physical address of the terminal and the Internet Protocol address of the network management server on the dynamic host configuration protocol server; wherein
determining the Internet Protocol address of the network management server comprises: parsing, by the dynamic host configuration protocol server, the physical address of the terminal from the dynamic host configuration protocol request, determining the Internet Protocol address of the network management server according to the parsed physical address of the terminal and the configured mapping relationship between the physical address of the terminal and the Internet Protocol address of the network management server.

15. The method according to claim 13, further comprising: configuring a unified Internet Protocol address of network management servers on the dynamic host configuration protocol server; wherein
determining the Internet Protocol address of the network management server comprises: selecting, by the dynamic host configuration protocol server, the unified Internet Protocol address of network management servers.

16. The method according to claim 13, further comprising: storing a mapping relationship between the physical address of the terminal and the terminal configuration file on the network management server; wherein
returning the terminal configuration file to the terminal comprises: determining, by the network management server, the terminal configuration file corresponding to the terminal according to the physical address of the terminal and the mapping relationship between the physical address of the terminal and the terminal configuration file stored on the network management server, and sending the terminal configuration file to the terminal.

17. The method according to claim 16, wherein the request requesting the network management server to provide the terminal configuration file carries the Internet Protocol address of the terminal;
before returning the terminal configuration file to the terminal, the method further comprises: determining, by the network management server, the physical address of the terminal initiating the request according to the Internet Protocol address of the terminal carried in the request.

18. The method according to claim 17, further comprising: sending, by the dynamic host configuration protocol server, the generated mapping relationship between the physical address and the Internet Protocol address of the terminal to the network management server; wherein
determining by the network management server the physical address of the terminal comprises: determining, by the network management server, the physical address of the terminal initiating the request according to the Internet Protocol address of the terminal comprised in the request and the mapping relationship between the physical address and the Internet Protocol address of the terminal sent from the dynamic host configuration protocol server.

19. The method according to claim 17, wherein determining by the network management server the physical address of the terminal comprises:
requesting, by the network management server, the dynamic host configuration protocol server to provide the physical address of the terminal corresponding to the Internet Protocol address of the terminal carried in the request.

20. The method according to claim 13, wherein when returning the terminal configuration file to the terminal, the method further comprises: sending, by the network management server, an Internet Protocol address of the service server to the terminal.

21. A system for service provision, comprising a terminal and a service server, wherein
the terminal is adapted to send a service request to the service server, and receive a service provided by the service server; and
the service server is adapted to store a mapping relationship between a physical address of the terminal and service information of a terminal user, receive the service request sent from the terminal, determine a service applied by the terminal user according to the physical address of the terminal and the mapping relationship between the physical address of the terminal and the service information of the terminal user, and provide the service to the terminal.

22. The system according to claim 21, wherein the service request carries an Internet Protocol address of the terminal;
the service server is further adapted to determine the physical address of the terminal initiating the service request according to the Internet Protocol address of the terminal carried in the service request.

23. The system according to claim 22, further comprising: a dynamic host configuration protocol server and a broadband remote access server, wherein
the terminal is further adapted to initiate a dynamic host configuration protocol request, requesting to allocate an Internet Protocol address, and receive the Internet Protocol address of the terminal sent from the dynamic host configuration protocol server;
the broadband remote access server is adapted to receive the dynamic host configuration protocol request initiated by the terminal, insert the physical address of the terminal into the dynamic host configuration protocol request, and send the dynamic host configuration protocol request with the physical address of the terminal to the dynamic host configuration protocol server; and
the dynamic host configuration protocol server is adapted to receive the dynamic host configuration protocol request, parse the physical address of the terminal from the dynamic host configuration protocol request, allocate an Internet Protocol address for the terminal, generate a mapping relationship between the physical address and the Internet Protocol address of the terminal, and send the allocated Internet Protocol address to the terminal.

24. The system according to claim 23, further comprising: a network management server, wherein
the terminal is further adapted to send a request to the network management server requesting the network management server to provide a terminal configuration file, receive the terminal configuration file sent from the network management server, to complete an initial configuration; and
the network management server is adapted to receive the request sent from the terminal, and return the terminal configuration file to the terminal.

25. The system according to claim 23, wherein the dynamic host configuration protocol server is further adapted to authenticate validity of the terminal.

26. The system according to claim 23, wherein the dynamic host configuration protocol server is further adapted to determine an Internet Protocol address of the service server when receiving the dynamic host configuration protocol request, and send the determined Internet Protocol address of the service server to the terminal;
the terminal is further adapted to receive the Internet Protocol address of the service server sent from the dynamic host configuration protocol server.

27. The system according to claim 24, wherein the dynamic host configuration protocol server is further adapted to determine an Internet Protocol address of the network management server, and send the determined Internet Protocol address of the network management server to the terminal; and
the terminal is further adapted to receive the Internet Protocol address of the network management server sent from the dynamic host configuration protocol server.

28. The system according to claim 24, wherein the network management server is further adapted to store a mapping relationship between the physical address of the terminal and the terminal configuration file, determine the terminal configuration file corresponding to the terminal according to the physical address of the terminal and the mapping relationship between the physical address of the terminal and the terminal configuration file stored on the network management server.

29. The system according to claim 24, wherein the network management server is further adapted to send an Internet Protocol address of the service server to the terminal;
the terminal is further adapted to receive the Internet Protocol address of the service server sent from the network management server.

30. The system according to claim 21, wherein the terminal is a set top box STB, or an integrated access device IAD, or a home gateway HGW, or a network telephone Ephone, or a personal computer PC, or any other next generation network terminal.
